(19) United States
(12) Patent Application Publication
(10) Pub. No.: US 2008/0040009 A1
(43) Pub. Date: Feb. 14, 2008

(54) Shift-position changing apparatus and method for automatic transmission

(75) Inventors: Atsushi Kamada, Nishikamo-gun (JP); Yoshinobu Nozaki, Anjyo-shi (JP); Yuji Inoue, Nissin-shi (JP); Masanori Miyakawa, Toyota-shi (JP); Shigeru Yoshiyama, Kariya-shi (JP); Taku Itoh, Chita-gun (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, TOYOTA-SHI (JP); DENSO CORPORATION, KARAIYA-CITY (JP)

(21) Appl. No.: 11/878,730

(22) Filed: Jul. 26, 2007

(30) Foreign Application Priority Data
Aug. 8, 2006 (JP) 2006-215961

(51) Int. Cl. B60W 10/10

(52) U.S. Cl. 701/51; 477/115

(57) ABSTRACT

A shift-position changing apparatus for an automatic transmission mounted in a vehicle includes a shift-position changing unit that moves a mechanical element using an actuator in response to the operation to change a shift-position to another shift-position instructed by the operation from among a plurality of shift-positions; and a setting member that places the mechanical element within a predetermined range independently of the operating state of the actuator.

### INCORPORATION BY REFERENCE

The disclosure of Japanese Patent Application No. 2006-215961 filed on Aug. 8, 2006 including the specification, drawings and abstract is incorporated herein by reference in its entirety.

### BACKGROUND OF THE INVENTION

1. Field of the Invention

The invention relates generally to a shift-position changing apparatus and method for an automatic transmission, which changes shift-positions (shift ranges) of an automatic transmission using an actuator, for example, a motor. More specifically, the invention relates to a shift-position changing apparatus and method for an automatic transmission, which allows the continued safe operation of a vehicle even when an actuator of the shift-position changing apparatus malfunctions.

2. Description of the Related Art

Automatic transmissions for vehicles are grouped into multi-speed automatic transmissions and continuously variable automatic transmissions. A multi-speed automatic transmission generally includes a fluid coupling, for example, a torque converter, and a speed-change gear mechanism. A continuously variable automatic transmission includes two pulleys of which the pulley-diameters are varied by hydraulic pressure, and a metal belt looped over these pulleys.

A multi-speed automatic transmission is connected to an engine via a fluid coupling, for example, a torque converter. The multi-speed automatic transmission includes a speed-change gear mechanism in which a plurality of power transfer paths may be formed. The multi-speed automatic transmission is structured such that the optimal power transfer path is automatically formed, namely, the optimal gear ratio (gear) is automatically selected in accordance with the accelerator pedal operation amount and the vehicle speed. In the multi-speed automatic transmission, clutches, brakes, and one-way clutches, which are all friction engaging elements, are engaged/released, in a predetermined manner, to select an appropriate gear.

A continuously variable automatic transmission is also connected to an engine via a fluid coupling, for example, a torque converter. For example, a belt-type continuously variable automatic transmission includes an endless metal belt and a pair of pulleys, and produces continuous speed ratios by continuously varying the pulley-diameters using hydraulic pressure. More specifically, the endless metal belt is looped over the input pulley fitted to the input shaft of the automatic transmission and the output pulley fitted to the output shaft of the automatic transmission. The input pulley and the output pulley each include a pair of sheaves. The width of a groove formed between these sheaves is continuously varied. Thus, the diameter of each of the loops formed by the endless metal belt looped over the input pulley and the output pulley is continuously varied. As a result, the rotational speed ratio between the input shaft and the output shaft, that is, the speed ratio is varied continuously.

A vehicle including either type of the automatic transmission described above is usually provided with a slide shift lever that is slid to a shift-position selected by a driver from among multiple shift-positions (Reverse, Neutral, Drive, etc.).

Recently, not only such shift-position changing apparatus provided with a slide shift lever but also a so-called “Shift-by-Wire” shift-position changing apparatus has been used. Such Shift-by-Wire shift-position changing apparatus detects a shift operation performed by a driver, using sensors and switches (sensors, etc.), and selects a shift-position from among multiple shift-positions based on detection signals from these sensors and switches. A selector for such Shift-by-Wire shift-position changing apparatus is not limited to a slide shift lever. Instead of a slide shift lever, operating members such as a so-called joystick or a push button may be employed. In the case of a shift-position changing apparatus provided with a joystick, the driver tilts a lever rightward/leftward and forward/rearward, whereby the shift-positions are changed.

Japanese Patent Application Publication No. JP-03-219165 (JP-A-03-219165) describes a Shift-by-Wire shift-position changing apparatus for an automatic transmission. This shift-position changing apparatus forcibly changes the shift-position to Park or Neutral to bring a vehicle into a standstill, if it is determined that the shift-position and the instructed shift-position, both indicated by signals, do not match each other after an actuator of the shift-position changing apparatus for an automatic transmission is operated. After such malfunction is corrected and no longer present, normal shift-position changing control is executed again. The shift-position changing apparatus for an automatic transmission includes a shift-position controller that issues an operation instruction to the actuator in response to a shift-position changing instruction from an operation unit; the actuator that changes the shift-positions of the automatic transmission in response to the operation instruction; a shift-position detection unit that detects the shift-position; and a determination unit that determines whether the shift-position matches the instructed shift-position. If the determination unit outputs a signal indicating that the shift-position does not match the instructed shift-position after the actuator is operated, the shift-position is forcibly changed to Park or Neutral.

If it is determined that the shift-position does not match the instructed shift-position after the actuator is operated, the shift-position changing apparatus for an automatic transmission forcibly changes the shift-position to Park or Neutral to bring the vehicle into a standstill. Accordingly, termination of the shift-position changing control due to, for example, a temporary malfunction in the shift-position detection unit is suppressed.

If it is determined that the shift-position does not match the instructed shift-position after the actuator is operated, the shift-position changing apparatus for an automatic transmission described in JP-A-03-219165 forcibly changes the shift-position to Park or Neutral using the actuator.

When the actuator itself malfunctions, although it is possible to determine whether the shift-position matches the instructed shift-position, it is not possible to forcibly change the shift-position to Park or Neutral even when it is determined that the shift-position does not match the instructed shift-position. In such a case, the shift-positions are not changed appropriately. As a result, a shift-position that does not appropriately reflect driver's intention may be undesirably selected.

### SUMMARY OF THE INVENTION

The invention provides a shift-position changing apparatus and method for an automatic transmission, which allows a continued safe operation of a vehicle even when an actuator of the shift-position changing apparatus malfunctions.

A first aspect of the invention relates to a shift-position changing apparatus that changes the shift-positions of an automatic transmission mounted in a vehicle. The shift-position changing apparatus includes a shift-position changing unit that moves a mechanical element using an actuator in response to an operation to change a shift-position to another shift-position instructed by the operation from among a plurality of shift-positions; and a setting member that places the mechanical element within a predetermined range independently of the operating state of the actuator.

The shift-position changing unit according to the first aspect of the invention rotates a manual shaft, which serves as the mechanical element of the automatic transmission, using the actuator, to change the shift-position to the other shift-position instructed by the operation from among the plurality of shift-positions. The setting member places the mechanical element within the predetermined range independently of the operating state of the actuator. For example, the setting member places the mechanical element within the predetermined range when the actuator malfunctions. As a result, it is possible to prevent undesirable changing of the shift-position to a shift-position that does not appropriately reflect driver's shift operation.

For example, when the vehicle is at a standstill and it is not possible to change the shift-positions using the actuator, the setting member places the mechanical element within the predetermined range to prevent changing of the shift-position to Non-Park, thereby maintaining the shift-position at Park. When the vehicle moves forward and it is not possible to change the shift-positions using the actuator, the setting member places the mechanical element within the predetermined range to prevent changing of the shift-position to Park, thereby maintaining the shift-position at Non-P (Drive, in this case). As a result, it is possible to provide the shift-position changing apparatus for an automatic transmission, which allows the continued safe operation of the vehicle even when the actuator of the shift-position changing apparatus malfunctions.

A second aspect of the invention relates to a shift-position changing method according to which shift-positions of an automatic transmission mounted in a vehicle are changed. According to the shift-position changing method, a mechanical element is moved by an actuator in response to an operation to change a shift-position to another shift-position instructed by the operation from among a plurality of shift-positions. The mechanical element is placed within a predetermined range when the actuator malfunctions.

### BRIEF DESCRIPTION OF THE DRAWINGS

The foregoing and further features and advantages of the invention will become apparent from the following description of example embodiments with reference to the accompanying drawings, wherein the same or corresponding portions will be denoted by the same reference numerals and wherein:

FIG. 1 is a block diagram showing the configuration of a shift-position control system according to the first embodiment of the invention;

FIG. 2 is a view showing the structure of the shift-position control mechanism in FIG. 1;

FIG. 3 is a view showing the operation of an emergency vehicle immobilizing actuator;

FIG. 4 is a block diagram showing the configuration of a shift-position control system according to the second embodiment of the invention;

FIG. 5 is a view showing the structure of a shift-position control mechanism in FIG. 4;

FIG. 6 is a flowchart showing the routine executed by a SBW-ECU in FIG. 4; and

FIG. 7 is a view showing the operation of an emergency vehicle immobilizing actuator according to the third embodiment of the invention.

### DETAILED DESCRIPTION OF EMBODIMENTS

Hereafter, embodiments of the invention will be described with reference to the accompanying drawings. In the description below, the same or corresponding components will be denoted by the same reference numerals. The functions and the names of the components having the same reference numerals are also the same. Accordingly, detailed description on the components having the same reference numerals will be provided only once below.

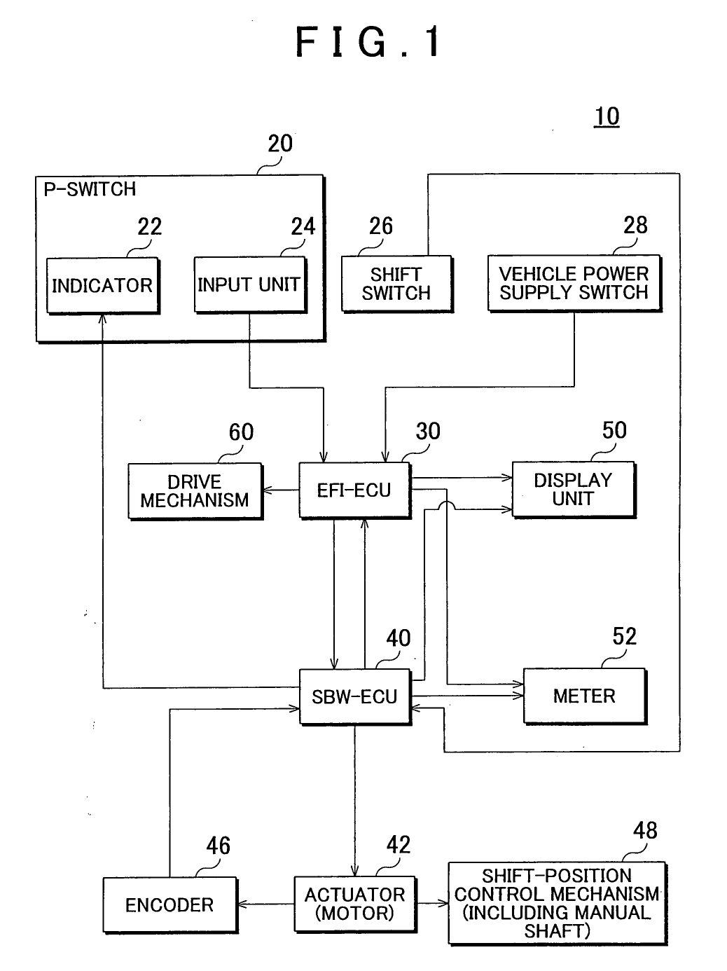

FIG. 1 shows the configuration of a shift-position control system 10 including a shift-position changing apparatus for an automatic transmission according to a first embodiment of the invention. If a malfunction has occurred, the shift-position changing apparatus for an automatic transmission changes the shift-position from a shift-position other than Park (hereinafter, referred to as Non-P) to Park P (hereinafter, referred to as P) in response to the operation performed by a driver.

The shift-position control system 10 is used to change the shift-positions for a vehicle. The shift-position control system 10 includes a P-switch 20, a shift switch 26, a vehicle power supply switch 28, a vehicle control unit (hereinafter, referred to as an “EFI-ECU”) 30, a parking control unit (hereinafter, referred to as a “SBW (Shift-by-Wire)-ECU”) 40, an actuator (motor) 42, an encoder 46, a shift-position control mechanism 48, a display unit 50, a meter 52, and a drive mechanism 60. The shift-position control system 10 functions as a Shift-by-Wire shift-position changing apparatus that changes the shift-positions under electric control. More specifically, the shift-position control mechanism 48 is driven by the actuator 42 to change the shift-positions.

The vehicle power supply switch 28 is used to change the on/off state of an electric power supply for a vehicle. Any type of switch, for example, an ignition switch may be employed as the vehicle power supply switch 28. An instruction that the vehicle power supply switch 28 receives from, for example, the driver is transmitted to the EFI-ECU 30. For example, when the vehicle power supply switch 28 is turned on, electric power is supplied from an auxiliary battery (not shown), whereby the shift-position control system 10 is actuated.

The P-switch 20 is used to change the shift-position between P and Non-P. The P-switch 20 includes an indicator 22 that indicates the current shift-position ( P or Non-P) to the driver, and an input unit 24 that receives an instruction from the driver. The driver inputs an instruction to change the shift-position to P in the P-switch 20 through the input unit 24. The input unit 24 may be a momentary switch. The instruction from the driver, which is received by the input unit 24, is transmitted to the EFI-ECU 30, and also to the SBW-ECU 40 through the EFI-ECU 30. A component other than the P-switch 20 may be used to change the shift-position from Non-P to P.

The SBW-ECU 40 controls the actuator 42 that drives the shift-position control mechanism 48 to change the shift-position between P and Non-P. The SBW-ECU 40 causes the indicator 22 to indicate the current shift-position (P or Non-P). If the driver presses the input unit 24 when the shift-position is in Non-P, the SBW-ECU 40 changes the shift-position to P, and causes the indicator 22 to indicate that the current shift-position is in P.

The actuator 42 is formed of a switched reluctance motor (hereinafter, referred to as a “SR motor”), and drives the shift-position control mechanism 48 in accordance with an instruction from the SBW-ECU 40. The encoder 46 rotates together with the actuator 42, and detects the rotational state of the SR motor. The encoder 46 is a rotary encoder that outputs an A-phase signal, a B-phase signal and a Z-phase signal. The SBW-ECU 40 receives a signal from the encoder 46 to determine the rotational state of the SR motor, and controls a supply of electric power used to drive the SR motor.

The shift switch 26 is used to change the shift-position to Drive (hereinafter, referred to as D), Reverse (hereinafter, referred to as R), Neutral (hereinafter, referred to as N), or the Brake (hereinafter, referred to as B). When the shift-position is in P, the shift switch 26 is used to change the shift-position from P to Non-P. An instruction from the driver, which is received by the shift switch 26, is transmitted to the EFI-ECU 30. The EFI-ECU 30 executes the control to change the shift-positions in the drive mechanism 60 in accordance with the instruction from the driver, and causes the meter 52 to indicate the shift-position. In the first embodiment of the invention, the drive mechanism 60 is formed of a continuously variable speed-change mechanism. Alternatively, the drive mechanism 60 may be formed of a multi-speed speed-change mechanism.

The EFI-ECU 30 comprehensively controls the operation of the shift-position control system 10. The display unit 50 indicates an instruction, an alert, etc. provided from the EFI-ECU 30 or the SBW-ECU 40 to the driver. The meter 52 indicates the conditions of the vehicle components and the current shift-position.

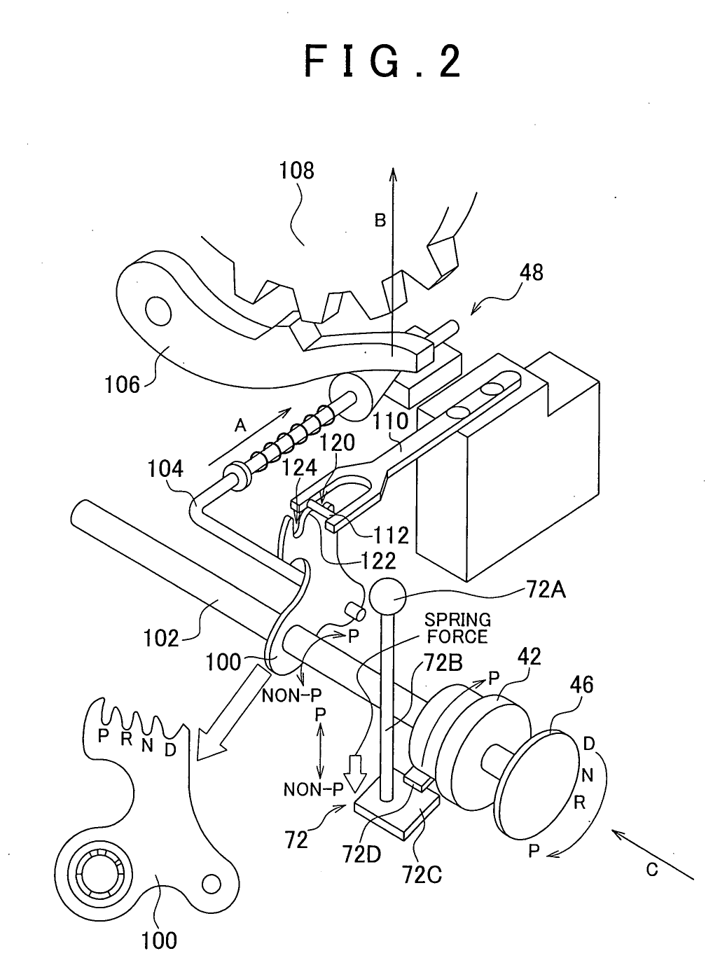

FIG. 2 shows the structure of the shift-position control mechanism 48. The shift-positions include P and Non-P including R, N, and D. Non-P may include, in addition to D, D1 at which first gear is always selected and D2 at which first or second gear (or only second gear) is always selected.

The shift-position control mechanism 48 includes a manual shaft 102 that is rotated by the actuator 42, a detent plate 100 that rotates along with the manual shaft 102, a rod 104 that operates in accordance with the rotation of the detent plate 100, a parking gear 108 that is fixed to the output shaft of a transmission (not shown), a parking gear locking pawl 106 that is used to lock the parking gear 108, a detent spring 110 that restricts the rotation of the detent plate 100 to fix the shift-position at a predetermined shift-position, and a roller 112. The manual shaft 102 functions as a mechanical element according to the invention.

The detent plate 100 is driven by the actuator 42 to change the shift-positions. The manual shaft 102, the detent plate 100, the rod 104, the detent spring 110 and the roller 112 serve, in combination, as a shift-position changing mechanism. The encoder 46 obtains a discrete value corresponding to the amount by which the actuator 42 rotates. The shift-position changing mechanism functions as shift-position changing means or a shift-position changing unit according to the invention.

In the perspective view in FIG. 2, only two of the indentations formed in the detent plate 100 (an indentation 124 corresponding to P and an indentation 120 corresponding to one of Non-P) are shown. However, the detent plate 100 actually has four indentations corresponding to D, N, R and P, as shown in the enlarged plane view of the detent plate 100 in FIG. 2. Changing of the shift-position between P and Non-P is described below. However, the invention is not limited to changing of the shift-position between P and Non-P.

FIG. 2 shows the state in which the shift-position is in Non-P. In this state, because the parking gear locking pawl 106 does not lock the parking gear 108, the rotation of the drive shaft of the vehicle is not interfered with. If the manual shaft 102 is then rotated in the clockwise direction, when viewed in the direction of the arrow C, by the actuator 42, the rod 104 is pressed via the detent plate 100 in the direction of the arrow A in FIG. 2, whereby the parking gear locking pawl 106 is pushed up in the direction of the arrow B in FIG. 2 by a tapered portion provided at the tip of the rod 104. As the detent plate 100 rotates, the roller 112 of the detent spring 110, which is positioned at one of the four indentations formed at the top portion of the detent plate 100, namely, the indentation 120 corresponding to Non-P climbs over a crest 122 and moves into the other indentation, namely, the indentation 124 corresponding to P. The roller 112 is fitted to the detent spring 110 so as to be rotatable about its axis. When the detent plate 100 rotates until the roller 112 reaches the indentation 124 corresponding to P, the parking gear locking pawl 106 is pushed up to a position at which the parking gear locking pawl 106 is engaged with the parking gear 108. Thus, the drive shaft of the vehicle is mechanically fixed, and the shift-position is changed to P.

In the shift-position control system 10, the SBW-ECU 40 controls the amount by which the actuator 42 rotates so that the impact caused when the roller 112 of the detent spring 110 drops into an indentation after climbing over the crest 122 is reduced to reduce the load placed on the shift-position changing mechanism including the detent plate 100, the detent spring 110 and the manual shaft 102.

The shift position mechanism 48 is provided with emergency vehicle immobilizing actuator 72 that has a mechanism operated by the driver. With the emergency vehicle immobilizing actuator 72, it is possible to change the shift-positions even when electric power supply to the shift-position control system 10 is shut off due to a malfunction in a power supply system for a vehicle when the vehicle is at a standstill. The emergency vehicle immobilizing actuator 72 functions as a setting member according to the invention.

The emergency vehicle immobilizing actuator 72 includes a knob 72A that is pulled up by the driver, a rod 72B that transfers the force, with which the knob 72A is pulled up against a spring force, to a plate 72C, and a lug portion 72D that is fitted to the manual shaft 102 and that is engaged with the plate 72C, when needed, to rotate the manual shaft 102. As shown in FIG. 2, pulling up the knob 72A changes the shift-position from Non-P to Park P.

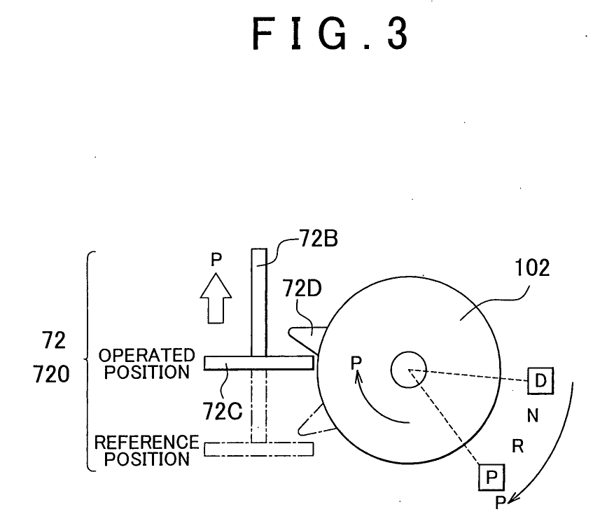

The lug portion 72D projects from the peripheral face of the manual shaft 102, and for example, it has a flat plate shape. As shown in FIG. 3, the position at which the lug portion 72D is provided is set based on the position corresponding to Park P and the position corresponding to Non-P (D in FIG. 3). In FIG. 3, the position of the plate 72C, which is reached when the rod 72B is operated downward to the fullest extent is shown, as the “reference position”, by the alternate long and short dotted lines, and the position of the plate 72C, which is reached when the rod 72B is operated upward to the fullest extent is shown, as the “operated position”, by the solid lines. The rod 72B is not limited to a linear member.

When the plate 72C is at the reference position that is reached when the rod 72B is operated downward to the fullest extent, the manual shaft 102 is rotated by the driving force of the actuator 42, and either Non-P or P may be selected. When the plate 72C is at the operated position that is reached when the rod 72 is operated upward to the fullest extent, even when the actuator 42 is driven, the rotation of the manual shaft 102 is restricted by the plate 72C, and the shift-position cannot be changed from P to Non-P. As indicated by the arrow P, moving the plate 72C from the reference position, at which the rod 72B is operated downward to the fullest extent, to the operated position at which the rod 72B is operated upward to the fullest extent, forcibly changes the shift-position from D to P. When the plate 72C is at the operated position that is reached when the rod 72B is operated upward to the fullest extent, the emergency vehicle immobilizing actuator 72 is in the operated state, that is, the emergency vehicle immobilizing actuator 72 has been pulled up by the driver.

When the emergency vehicle immobilizing actuator 72 is in the operated state, the knob 72A has been pulled up by the driver against the spring force. Accordingly, if the driver stops pulling up and releases the knob 72A, the plate 72C is moved to the reference position by the spring force, and the emergency vehicle immobilizing actuator 72 is no longer in the operated state. However, the shift-position is maintained at P. A component that applies a force to the plate 72C is not limited to a spring. Such force may be an electric force, an elastic force that is generated by a component other than a spring, a pressure, a magnetic force, etc. When the plate 72C is at the reference position, the shift-positions can be changed in a usual manner. A force for maintaining the shift-position at P may also be a spring force, an electric force, an elastic force that is generated by a component other than a spring, a pressure, a magnetic force, or the like.

The operation of the thus structured shift-position control system 10 will be described. When the vehicle is at a standstill, if a malfunction has occurred in the power supply system, for example, if an indicator of an instrument panel is entirely turned off although the ignition switch is not off, the Shift-by-Wire shift-position control system 10 cannot change the shift-position from Non-P to P. In a vehicle that includes an electric parking brake instead of a manual parking brake, the parking brake malfunctions as well.

In such a case, the driver pulls up the knob 72A to bring the emergency vehicle immobilizing actuator 72 in the operated state, to change the shift-position from Non-P to P. When the knob 72A is pulled up, the shift-position is changed to P, as shown in FIG. 3. When the driver releases the knob 72A after this, the rod 72B is moved downward by the spring force, and the plate 72C returns to the reference position. However, the shift-position is maintained at P.

As described above, with the shift-position control system 10 including the shift-position control apparatus, even when a malfunction has occurred in the electrical system of the vehicle equipped with the “Shift-by-Wire” shift-position changing apparatus, the shift-position is reliably changed from Non-P to P.

When the emergency vehicle immobilizing actuator 72 is in the operated state, the shift-position may be changed from Non-P to P and maintained at P. Alternatively, the shift-position may be changed from P to Non-P and maintained at Non-P.

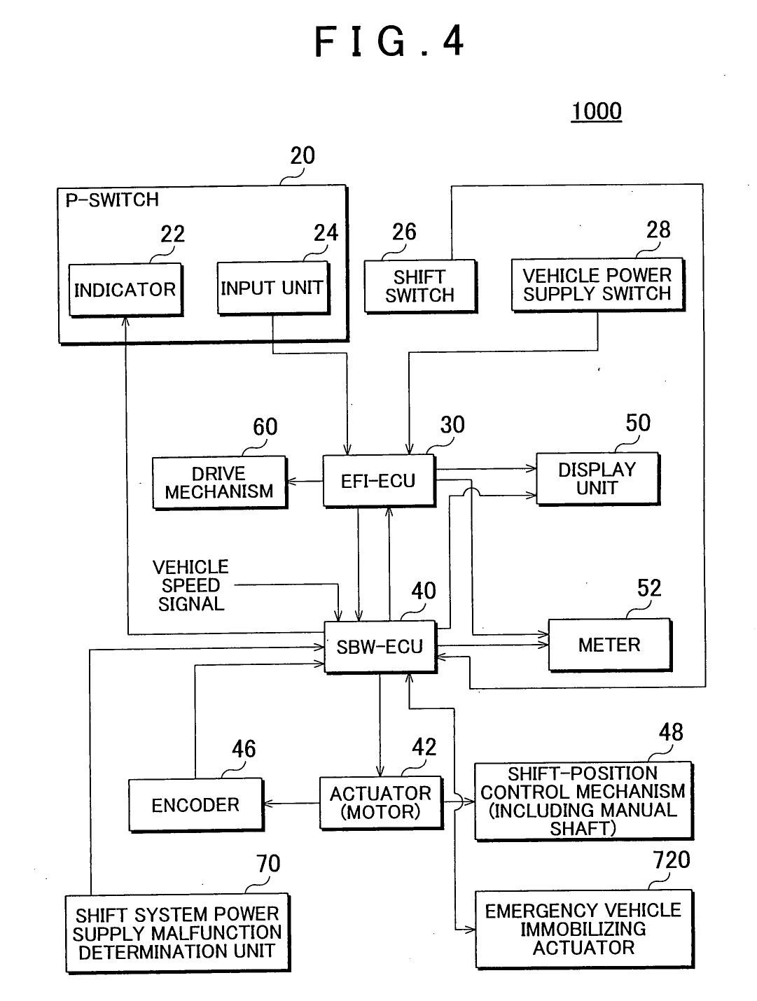

FIG. 4 shows a shift-position changing system 1000 including a shift-position changing apparatus for an automatic transmission according to a second embodiment of the invention. The shift-position control system 10 including the shift-position changing apparatus for an automatic transmission according to the first embodiment of the invention changes the shift-position from Non-P to P in response to the driver's operation. In contrast, according to the second embodiment of the invention, the shift-position is changed to P by an electric drive power source.

The control system 1000 shown in FIG. 4 has mostly the same structure as the shift-position control system 10 shown in FIG. 1 except that the control system 1000 further includes a shift system power supply malfunction determination unit 70. The shift system power supply malfunction determination unit 70 determines whether a malfunction has occurred in a power supply for a shift system, and transmits, if determining that a malfunction has occurred, a signal indicating occurrence of a malfunction to the SBW-ECU 40. The shift-position control system 1000 includes the shift-position control system 10, and determines whether a malfunction has occurred in the power supply that supplies electric power to the shift-position control mechanism 48. As described above, the shift-position control system 10 is actuated by being supplied with electric power from the auxiliary battery. A current sensor (not shown) is provided on an electric power supply line through which electric power is supplied to the shift-position control mechanism 48 to monitor a current value, whereby whether a malfunction has occurred in the power supply is determined.

The shift-position control system 1000 shown in FIG. 4 is provided with an emergency vehicle immobilizing actuator 720 that is controlled according to the later-described routine executed by the SBW-ECU 40 when the shift system power supply malfunction determination unit 70 detects a malfunction in the power supply. The emergency vehicle immobilizing actuator 720 is driven not by the force applied by the driver but by a motor that is driven by an electric power supply circuit which is separate from the electric power supply circuit (auxiliary battery) of the actuator 42. Alternatively, the emergency vehicle immobilizing actuator 720 may be driven by a pressure such as a pneumatic or a hydraulic pressure supplied from a pressure source (for example, a pump) that is driven by an electric power supply circuit that is separate from the electric power supply circuit (auxiliary battery) of the actuator 42. The emergency vehicle immobilizing actuator 720 may be driven by, for example, a magnetic force.

Namely, the emergency vehicle immobilizing actuator 72 places the manual shaft 102, which is used to select the shift-position, into a predetermined rotational position. For example, the emergency vehicle immobilizing actuator 720 places the manual shaft 102 into a predetermined rotational position such that the shift-position is changed from Non-P to P and maintained at P, or the shift-position is changed from P to Non-P and maintained at Non-P. The types of a drive power source for changing the shift-positions and maintaining the shift-position are not limited to electric power supply sources and mechanical (pneumatic pressure, hydraulic pressure, spring, magnetic force, etc.) power supply sources as long as the power supply source is separate from the drive power source (auxiliary battery) for the actuator 42.

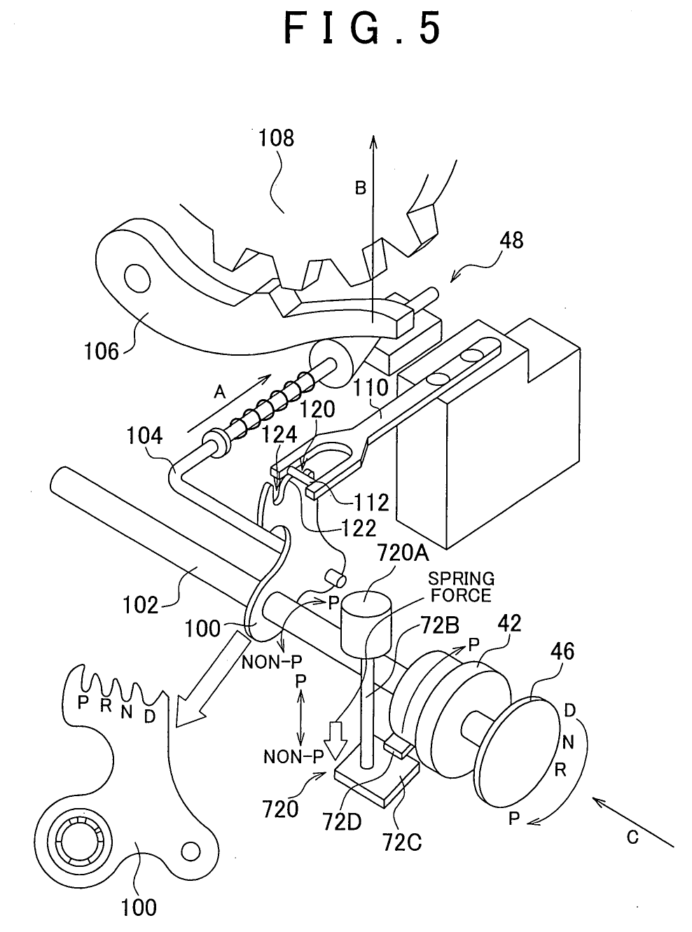

More specifically, the emergency vehicle immobilizing actuator 720 has the structure shown in FIG. 5. In the description below, the drive power source for the emergency vehicle immobilizing actuator 720 is an electric motor, and the electric power supply circuit for the electric motor is separate from the electric power supply circuit (auxiliary battery) for the actuator 42.

The emergency vehicle immobilizing actuator 720 includes an electric motor 720A, the rod 72B that transfers the driving force generated by the electric motor 720A to the plate 72C, and the lug portion 72D that is fitted to the manual shaft 102 and that is engaged with the plate 72C, when needed, to rotate the manual shaft 102. The electric motor 720A gradually moves the emergency vehicle immobilizing actuator 720 upward in the direction of the arrow P, in which the shift-position is changed to P, or moves the emergency vehicle immobilizing actuator 720 downward in the direction of the arrow Non-P, in which the shift-position is changed to Non-P. The electric motor 720A generates the driving force that is used to drive the emergency vehicle immobilizing actuator 720 instead of the operating force applied by the driver.

According to the second embodiment of the invention as well, when the electric motor 720A is not operated, the plate 72C is maintained at the reference position by the spring force, and the emergency vehicle immobilizing actuator 720 is no longer in the operated state.

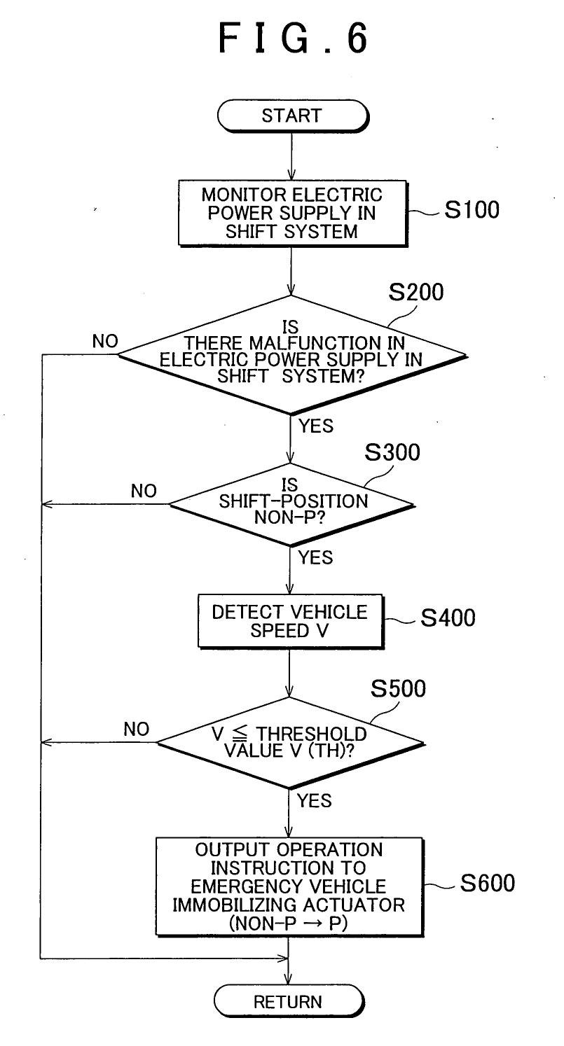

The routine executed by the SBW-ECU 40 in FIG. 4 will be described with reference to FIG. 6. The routine is periodically executed at predetermined time intervals.

In step (hereinafter, simply referred to as “S”) 100, the SBW-ECU 40 monitors electric power supply in the shift system using a shift system power supply malfunction determination unit. Namely, the SBW-ECU 40 monitors whether electric power is properly supplied to the shift-position control mechanism 48 of the shift-position control system 10.

In S200, the SBW-ECU 40 determines whether there is a malfunction in the electric power supply in the shift system. If it is determined that there is a malfunction in the electric power supply in the shift system (“YES” in S200), S300 is executed. On the other hand, if it is determined that there is no malfunction (“NO” in S200), the routine ends.

In S300, the SBW-ECU 40 determines whether the actual shift-position is in Non-P. The determination is made based on a signal from a shift-position sensor. If it is determined that the shift-position is in Non-P (“YES” in S300), S400 is executed. On the other hand, if it is determined that the shift-position is in P (“NO” in S300), the routine ends.

In S400, the SBW-ECU 40 detects the vehicle speed V. In S500, the SBW-ECU 40 determines whether the vehicle speed V is equal to or lower than the threshold value V (TH). The threshold value V (TH) is set, for example, to a value close to zero. If it is determined that the vehicle speed V is equal to or lower than the threshold value V (TH) (“YES” in S500), S600 is executed. On the other hand, if it is determined that the vehicle speed V is higher than the threshold value V (TH) (“NO” in S500), the routine ends.

In S600, the SBW-ECU 40 outputs an operation instruction to the emergency vehicle immobilizing actuator 720. Then, as shown in FIG. 5, the rod 72B is moved upward, and the plate 72C is moved from the reference position upward to the operated position. At this time, the plate 72C shown in FIG. 3 is engaged with the lug portion 72D indicated by the alternate long and short dotted line, and rotates the manual shaft 102 in the direction of the arrow P (clockwise direction) until the lug portion 72D reaches the position indicated by the solid line.

The operation of the shift-position control system 1000 that has the above-described structure and executes the above-described routine will be described below.

The electric power supply in the shift system is monitored (S100). If it is determined that a malfunction has occurred (“YES” in S200), the shift-position is in Non-P (“YES” in S300), and the vehicle is at a standstill (“YES” in S500), the emergency vehicle immobilizing actuator 720 is actuated (S600). At this time, the emergency vehicle immobilizing actuator 720 is operated to change the shift-position from Non-P to P. Namely, the electric motor 720A is controlled so that the rod 72B is moved upward.

With the shift-position control system 1000 including the shift-position control apparatus, even when a malfunction has occurred in the electric system (the auxiliary battery) of the actuator 42 that rotates the manual shaft 102 in the vehicle including the Shift-by-Wire shift-position changing apparatus, the shift-position is reliably changed from Non-P to P.

Hereafter, a modified example of the second embodiment of the invention will be described.

According to the modified example of the second embodiment of the invention, the following steps are executed in addition to the steps in the routine shown in FIG. 6. If it is determined that the malfunction in the electric power supply in the shift system is corrected and no longer present after S600 is completed (“NO” in S200), the SBW-ECU 40 outputs an operation instruction to the emergency vehicle immobilizing actuator 720 (an operation instruction to move the plate 72C from the operated position to the reference position). At this time, as shown in FIG. 3, the rod 72B is moved in the direction opposite to the direction of the arrow P, and the plate 72C returns from the operated position downward to the reference position. At this time, because the plate 72C is not engaged with the lug portion 72D, the plate 72C does not rotate the manual shaft 102. However, either Non-P or P may be selected by rotating the manual shaft 102 using the actuator 42.

The shift-position control system 1000 according to the modified example of the second embodiment of the invention may be structured such that a spring force is not required.

If it is determined that there is a malfunction in the electric power supply in the shift system (“YES” in S200), and it is determined that the vehicle speed is higher than the threshold value V (TH) (“NO” in S500), the SBW-ECU 40 operates the emergency vehicle immobilizing actuator 720 to move the plate 72C from the operated position downward to the reference position. Namely, the plate 72C is maintained at the reference position. Thus, even when it becomes impossible to rotate the manual shaft 102 using the actuator 42 while the vehicle moves, the plate 72C is maintained at the reference position.

In the modified example, the driving force used to maintain the plate 72C at the reference position is not limited to the force generated by the electric motor. Such driving force may be a mechanically applied force, a pressure such as a pneumatic or a hydraulic pressure, a magnetic force, or a spring force as in the first embodiment of the invention.

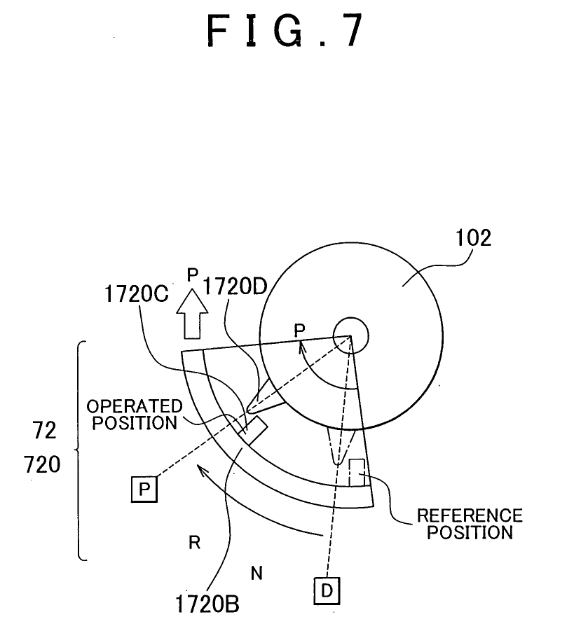

FIG. 7 shows a third embodiment of the invention. The third embodiment of the invention may be applied to either the emergency vehicle immobilizing actuator 72 according to the first embodiment of the invention or the emergency vehicle immobilizing actuator 720 according to the second embodiment of the invention. According to the third embodiment of the invention, the driving force applied by the driver or the driving force generated by the electric motor is used to pivot an arc-shape member 1720B, arranged so as to partially surround the manual shaft 102, about the axis of the manual shaft 102 from the position corresponding to D to the position corresponding to P.

At the reference position that is reached when the arc-shaped member 1720B pivots counterclockwise to the fullest extent, either Non-P or P may be selected by rotating the manual shaft 102 using the driving force of the actuator 42. At the operated position that is reached when the arc-shaped member 1720B pivots clockwise to the fullest extent, the rotation of the manual shaft 102 is restricted even when the actuator 42 is driven, and the shift-position cannot be changed from P to Non-P.

When the arc-shaped member 1720B pivots clockwise (the direction of the arrow P), the shift-position is forcibly changed from D to P. A lug portion 1720D projects from the peripheral face of the manual shaft 102, and has a flat plate shape. As shown in FIG. 5, the position at which the lug portion 1720D is provided is determined based on the position corresponding to P and the position corresponding to Non-P (D in FIG. 7).

When a malfunction has occurred, the arc-shaped member 1720B, which serves as an actuator, changes the shift-position from Non-P to P in response to the driver's operation as in the first embodiment of the invention, or using the electric motor as in the second embodiment of the invention.

The shift-position changing apparatus according to the invention may be applied to any one of an automatic transmission that executes the gear control in which the gear corresponding to the shift-position selected by the driver is used, and an automatic transmission that executes the shift-range control in which the gear corresponding to the shift-position selected by the driver and the gears lower than the selected gear are all used.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are example, other combinations and configurations, including more, less or only a single element, are also within the spirit and scope of the invention.

What is claimed is:

1. A shift-position changing apparatus for an automatic transmission mounted in a vehicle, comprising:
a shift-position changing unit that moves a mechanical element using an actuator in response to an operation to change a shift-position to another shift-position instructed by the operation from among a plurality of shift-positions; and
a setting member that places the mechanical element within a predetermined range independently of an operating state of the actuator.

2. The shift-position changing apparatus for an automatic transmission according to claim 1, wherein
the shift-position changing unit rotates the mechanical element using the actuator to change the shift-position to the other shift-position by the operation from among the plurality of shift-positions.

3. The shift-position changing apparatus for an automatic transmission according to claim 1, wherein
the setting member allows the mechanical element to rotate in only one direction.

4. The shift-position changing apparatus for an automatic transmission according to claim 2, wherein
the setting member allows the mechanical element to rotate in only one direction.

5. The shift-position changing apparatus for an automatic transmission according to claim 1, wherein
the setting member places the mechanical element within the predetermined range when a speed of a vehicle is equal to or lower than a predetermined value.

6. The shift-position changing apparatus for an automatic transmission according to claim 3, wherein
the setting member includes:
an engagement portion that is arranged on a periphery of the mechanical element; and
a member that is arranged near the mechanical element and that engages with the engagement portion to place the mechanical element within the predetermined range.

7. The shift-position changing apparatus for an automatic transmission according to claim 1, wherein
the setting member places the mechanical element within the predetermined range to change the shift-position to Park or any one of the shift-positions other than Park.

8. The shift-position changing apparatus for an automatic transmission according to claim 7, further comprising:
a member that locks a drive shaft of a vehicle at the same time that the shift-position is changed to Park.

9. The shift-position changing apparatus for an automatic transmission according to claim 1, wherein,
when the actuator malfunctions, the setting member places the mechanical element within the predetermined range by at least one of an operation performed by a driver and a drive power source that is operative even when the actuator malfunctions.

10. The shift-position changing apparatus for an automatic transmission according to claim 9, further comprising:
a current sensor that monitors electric power supply to the shift-position changing apparatus for an automatic transmission; and
a malfunction determination unit that determines whether the actuator has malfunctioned based on a signal output from the current sensor.

11. The shift-position changing apparatus for an automatic transmission according to claim 1, wherein
the setting member places the mechanical element within the predetermined range using at least one of a force generated by electric power supplied through an electric power supply line that is separate from an electric power supply line for the actuator and a mechanical force that is obtained without using electric power, independently of the operating state of the actuator.

12. The shift-position changing apparatus for an automatic transmission according to claim 6, further comprising:
a holding member that holds the setting member within a predetermined range in which the setting member does not interfere with changing of the shift-positions when the setting member is not operated.

13. The shift-position changing apparatus for an automatic transmission according to claim 12, wherein
the holding member is driven by at least one of electric power, elastic force, pressure and magnetic force.

14. The shift-position changing apparatus for an automatic transmission according to claim 6, further comprising:
a maintaining member that maintains the mechanical element within the predetermined range after an operation of the setting member ends.

15. The shift-position changing apparatus for an automatic transmission according to claim 14, wherein
the maintaining member is driven by at least one of electric power, elastic force, pressure and magnetic force.

16. A shift-position changing method for an automatic transmission mounted in a vehicle, comprising:
moving a mechanical element using an actuator in response to an operation to change a shift-position to another shift-position instructed by the operation from among a plurality of shift-positions; and
placing the mechanical element within a predetermined range when the actuator malfunctions.

17. The shift-position changing method for an automatic transmission according to claim 16, wherein
the mechanical element is placed within the predetermined range such that the shift-position is changed to Park or any one of the shift-positions other than Park.

18. The shift-position changing method for an automatic transmission according to claim 16, further comprising:
locking a drive shaft of a vehicle at the same time that the shift-position is changed to Park.

19. The shift-position changing method for an automatic transmission according to claim 16, wherein,
the mechanical element is placed within the predetermined range by a drive power source that is operative even when the actuator malfunctions.

20. The shift-position changing method for an automatic transmission according to claim 19, wherein
a force produced by the drive power source is at least one of a force generated by electric power supplied through an electric power supply line that is separate from an electric power supply line for the actuator and a mechanical force that is obtained without using electric power.
